(19) United States
(12) Patent Application Publication
(10) Pub. No.: US 2025/0314278 A1
(43) Pub. Date: Oct. 9, 2025

(54) VEHICLE MOUNT AND A MANUFACTURING METHOD THEREOF

(71) Applicants: HYUNDAI MOTOR COMPANY, Seoul (KR); KIA CORPORATION, Seoul (KR)

(72) Inventor: Seung Won Kim, Seoul (KR)

(73) Assignees: HYUNDAI MOTOR COMPANY, Seoul (KR); KIA CORPORATION, Seoul (KR)

(21) Appl. No.: 18/887,788

(22) Filed: Sep. 17, 2024

(30) Foreign Application Priority Data
Apr. 8, 2024 (KR) 10-2024-0047070

(51) Int. Cl. F16F 1/373

(52) U.S. Cl. CPC F16F 1/3735; F16F 2226/04

(57) ABSTRACT

A vehicle mount and a manufacturing method thereof are provided. The vehicle mount includes an inner pipe, an outer pipe disposed outside the inner pipe, a main rubber part interposed between the inner pipe and the outer pipe, and a middle pipe embedded in and coupled to the main rubber part. The middle pipe includes two ring parts spaced apart from each other and disposed at opposite axial ends of the mount, connection parts each formed to connect the two ring parts, and flap parts each formed at a corresponding one of the ring parts. Each of the flap parts is bent so as to be inclined outwards in a radial direction of the mount, and each of the flap parts is deformed, when a pipe diameter reducing process is performed to remove or relieve residual stress in the main rubber part, inwards in the radial direction of the mount.

### CROSS-REFERENCE TO RELATED APPLICATION

This application claims, under 35 U.S.C. § 119 (a), the benefit of and priority to Korean Patent Application No. 10-2024-0047070, filed on Apr. 8, 2024, the entire contents of which are incorporated herein by reference.

### BACKGROUND

### (a) Technical Field

The present disclosure relates to a vehicle mount and a manufacturing method thereof capable of relieving residual stress generated in a main rubber part and preventing deterioration in durability due to the residual stress.

### (b) Background Art

In general, when a powertrain including an engine and a transmission of an internal combustion engine vehicle is mounted in an engine compartment, a mount is used to reduce vibration and noise transmitted from the powertrain to a vehicle body. For example, an engine mount serves to isolate, during driving of the engine, vibration generated by stroke movement of a piston and rotational torque of a crankshaft from the vehicle body.

Unlike the internal combustion engine vehicle having the engine mounted therein, an electric vehicle is configured to use a power electric (PE) system including a motor and a reducer. Therefore, when the motor and the reducer are mounted on the vehicle body side in a PE room, the electric vehicle uses a dedicated electric vehicle mount capable of isolating gear fine noise, shock, and jerk vibration.

Each of the motor and the reducer for the PE system of the electric vehicle has a lower weight than an engine (i.e., internal combustion engine). Therefore, in the electric vehicle, as a mount for the PE system, a conventional rubber type mount is mainly used instead of a hydro-type mount. For example, a rubber mount (bushing mount) is widely used as a mount for the PE system of the electric vehicle, in which the rubber mount is formed by integrally combining a main rubber part with an inner pipe and an outer pipe.

As shown in FIGS. 1 and 2, a rubber mount 1 includes an inner pipe 2 (also referred to as an “inner core”) to perform coupling with a device mounted in a vehicle, such as a motor or a reducer, a main rubber part 3 (also referred to as an “isolator”) vulcanized and molded into a predetermined shape on the outer diameter of the inner pipe 2, and an outer pipe 4 integrally coupled to the outer surface of the main rubber part 3.

Among the above-described components of the rubber mount, a rubber part (e.g., the main rubber part 3) performs a function of isolating vibration transmitted from the motor and the reducer through the inner pipe 2 to prevent the vibration from being transmitted to the outer pipe 4 coupled to a vehicle body.

When a motor (not shown) is mounted in an electric vehicle using the rubber mount 1, the outer pipe 4 of the rubber mount 1 is press-fitted into a mounting hole of a subframe (not shown) on the vehicle body side, and a bolt (not shown) is inserted into a shaft insertion hole 2a of the inner pipe 2 and is coupled to the motor.

There is known a mount configured to allow a middle pipe to be inserted into a main rubber part (isolator) when the main rubber part (isolator) is vulcanized and molded. With respect to a bushing-type fluid mount including a main rubber part or a mount requiring increased axial characteristics, as described above, the middle pipe needs to be provided in the main rubber part.

A mount including a middle pipe is expected to be used more widely in an electric vehicle in the future. The reason for this is that when the mount including the middle pipe is used, a three-way characteristic ratio may be adjusted, and high-frequency dynamic characteristics may be improved.

However, when a middle pipe is applied to a rubber mount, it is impossible to perform a pipe diameter reducing process (pipe swaging). Accordingly, there is a problem in that durability of a mount including a main rubber part deteriorates. In detail, when a mount is manufactured, in addition to general processes, a pipe diameter reducing process (pipe swaging) is performed to relieve residual stress within the main rubber part.

In other words, shrinkage occurs in the process of vulcanizing the main rubber part and cooling the same to room temperature. Since rubber shrinks much more than metal, residual stress due to rubber shrinkage occurs between an inner pipe and an outer pipe, and the residual stress causes the inner pipe and the outer pipe to pull each other. When the main rubber part is tensioned in this state, the main rubber part may be easily damaged.

To address the above-described problem, a pipe diameter reducing process (pipe swaging) is performed on the outer pipe to reduce a distance between the inner pipe and the outer pipe, thereby relieving residual stress present in the main rubber part. The pipe diameter reducing process is a process of reducing the outer diameter of the mount (diameter of the outer pipe) after the main rubber part is vulcanized and molded.

FIG. 3 is views illustrating the pipe diameter reducing process. Specifically, FIG. 3 is a cross-sectional view showing a state in which rubber is vulcanized and molded using a cylindrical pipe. The left view shows a state in which vulcanized rubber R is not cooled. In this state, the rubber R is at a high temperature (for example, 130° C.). The rubber R corresponds to a main rubber part of a mount, and pipes P1 and P2 respectively correspond to an outer pipe and an inner pipe.

The middle view of FIG. 3 shows a state in which the vulcanized rubber R is cooled to room temperature (for example, 25° C.). When the vulcanized rubber R is cooled to room temperature, rubber shrinks and residual stress occurs therein. In this state, residual stress in the rubber R causes the pipes P1 and P2 to pull each other, which leads to deterioration in durability.

Since residual stress causes deterioration in durability of rubber, it is desired to eliminate residual stress present in rubber. To eliminate residual stress present in rubber, it is required to perform a process of reducing a vertical length of rubber (a rubber bushing) shown in FIG. 3.

In this case, a pipe diameter reducing process (pipe swaging) is performed to reduce a diameter of a pipe by evenly applying force acting inwards in the radial direction of the outer circumferential surface of the pipe. In this manner, a length of rubber (for example, a length of a bridge portion) is reduced, thereby relieving residual stress present in rubber.

However, when a middle pipe is applied to the mount, it is difficult to relieve, during the pipe diameter reducing process, residual stress present in the main rubber part because the middle pipe is present between the pipes. As a result, durability of the mount including the main rubber part may be significantly reduced.

When a metallic middle pipe is installed in a mount, the middle pipe protects against external force acting inwards in the radial direction while a pipe diameter reducing process is performed on an outer pipe. Accordingly, there is no change in a main rubber part inside the middle pipe and, as such, residual stress present in the main rubber part may not be relieved. Accordingly, the main rubber part inside the metallic middle pipe may be damaged during tensioning.

Additionally, in a case where a middle pipe is inserted into a space between an inner pipe and an outer pipe, when force acting inwards is exerted on the outer pipe to reduce the diameter of the outermost outer pipe, force may not be evenly transmitted to the middle pipe disposed therebetween, which may cause bending of the middle pipe.

Furthermore, the middle pipe may be distorted, and a part of the middle pipe may protrude outwards from opposite ends in the axial direction of the mount. In detail, the middle pipe has a through hole formed at a middle portion thereof. Therefore, when force acting inwards in the radial direction is exerted on the middle pipe during the pipe diameter reducing process, severe distortion of the middle pipe may occur.

FIG. 4 is a cross-sectional view showing a state in which a pipe diameter reducing process is impossible due to the middle pipe, and the rubber R is vulcanized and molded in a space between a pipe P1 and one of pipes P3, a space between one of the pipes P3 and the other one of the pipes P3, and a space between the other one of the pipes P3 and a pipe P2.

In comparison with a configuration of the mount, the outer pipe P1 in the drawing corresponds to the outer pipe, and the inner pipe P2 corresponds to the inner pipe. Additionally, the pipes P3 disposed between the outer pipe P1 and the inner pipe P2 correspond to the middle pipe. The drawing on the left side of FIG. 4 shows a state immediately after the rubber R is vulcanized and molded. In this state, the rubber R is not cooled yet, so the rubber R is at a high temperature (for example, 130° C.).

On the other hand, the drawing in the middle of FIG. 4 shows a state in which the rubber R is cooled to room temperature (for example, 25° C.). The rubber R contracts during a cooling process, and residual stress occurs inside the rubber R. After the cooling process, residual stress in the rubber R causes the outer pipe 1 and the inner pipe 2 to pull each other, which leads to deterioration in durability.

The drawing on the right side of FIG. 4 shows a state in which a pipe diameter reducing process (pipe swaging) is performed by applying force acting inwards in the radial direction to the outer circumference surface of the outer pipe P1. Even if the pipe diameter reducing process is performed to relieve residual stress, residual stress is still present in the rubber between the middle pipes P3, which causes deterioration in durability.

The above information disclosed in this Background section is provided only to enhance understanding of the background of the disclosure, and therefore it may contain information that does not form the prior art that is already known to a person of ordinary skill in the art, and the statements in this Background section may not constitute prior art.

### SUMMARY

The present disclosure has been made in an effort to solve the above-described problems associated with the prior art, and it is an object of the present disclosure to provide a vehicle mount and a manufacturing method thereof capable of relieving residual stress generated in a main rubber part and preventing deterioration in durability due to the residual stress.

The objects of the present disclosure are not limited to the above-mentioned objects, and other technical objects not mentioned herein should be clearly understood by those having ordinary skill in the art to which the present disclosure pertains (referred to hereinafter as “those skilled in the art”) from the detailed description of the embodiments.

In one aspect of the present disclosure, a vehicle mount includes: an inner pipe; an outer pipe disposed outside the inner pipe; a main rubber part interposed between the inner pipe and the outer pipe; and a middle pipe embedded in the main rubber part and coupled to the main rubber part. The middle pipe includes two ring parts spaced apart from each other and respectively disposed at each of opposite axial ends of the mount, connection parts each formed to connect the two ring parts to each other, and flap parts each formed at a corresponding one of the two ring parts. Each of the flap parts is bent such that each of the flap parts is inclined outwards in a radial direction of the mount. When a pipe diameter reducing process is performed on the outer pipe to relieve residual stress in the main rubber part, each of the flap parts is configured to be deformed inwards in the radial direction of the mount by the outer pipe having a reducible diameter so that an inclination angle of each of the flap parts is changed relative to the corresponding one of the ring parts.

In an embodiment, each of the flap parts may be formed along a corresponding one of edge portions of the two ring parts. The edge portions may face each other. Each of the flap parts may be formed to have a plate shape protruding toward an opposite one of the two ring parts.

In another embodiment, the middle pipe may have two connection parts formed to extend in an axial direction of the mount and connect the two ring parts to each other. Each of the flap parts may be formed at the corresponding one of the two ring parts and formed between the two connection parts.

In still another embodiment, each of the flap parts may be formed to have a predetermined length in a circumferential direction of the corresponding one of the two ring parts and formed between the two connection parts. Recessed portions may be respectively formed in each of spaces between each of opposite ends of the flap parts and the two connection parts, and at sections having the recessed portions respectively formed therein, only corresponding portions of the two ring parts are formed.

In yet another embodiment, each of the two ring parts may have a hemming part, the hemming part having an edge end. The edge end of the hemming part of each of the two ring parts may respectively correspond to each of opposite end positions of the mount in an axial direction, the edge end of the hemming part of each of the wo ring parts may be folded inwards in the radial direction.

In still yet another embodiment, the middle pipe may have grooves each formed on an outer circumferential surface of the middle pipe. Each of the grooves may be formed along a corresponding one of boundary lines respectively formed between each of the two ring parts and each of the flap parts. Each of the flap parts may be bent, from a corresponding one of the grooves, outwards in the radial direction of the mount relative to each of the two ring parts before performing the pipe diameter reducing process.

In a further embodiment, a flow path groove may be formed on an outer circumferential surface of the main rubber part. The flow path groove may extend in a circumferential direction. The main rubber part may have bridge portions respectively located at opposite sides of the flow path groove in a cross section of the mount. The ring parts and the flap parts of the middle pipe may be embedded in the bridge portions.

In another further embodiment, each of the flap parts may maintain, after the pipe diameter reducing process is performed, a state of being embedded in the main rubber part without bending relative to the corresponding one of the ring parts. After the pipe diameter reducing process is performed, rubber portions of the main rubber part may contact an inner circumferential surface of the outer pipe and surround the ring parts and the flap parts.

In still another further embodiment, the main rubber part may have rubber grooves respectively formed on surfaces exposed outwards from the respective bridge portions of the main rubber part, wherein each of the rubber grooves may relieve residual stress concentration during cooling after vulcanization molding of the main rubber part.

In yet another further embodiment, the rubber grooves may be respectively formed on an upper side of the inner pipe and a lower side thereof, and each of the rubber grooves may be formed to have a shape extending to have a predetermined length in the circumferential direction.

In another aspect, the present disclosure provides a manufacturing method of a vehicle mount, the manufacturing method including: performing vulcanization molding of a main rubber part after placing an inner pipe and a middle pipe in a mold; coupling orifice members to the main rubber part such that the orifice members are positioned between flow path grooves formed in the main rubber part cooled after the vulcanization molding; assembling an outer pipe with an outer side of the main rubber part in a state in which the orifice members are coupled to the main rubber part; and performing a pipe diameter reducing process to relieve residual stress in the main rubber part and reduce a diameter of the outer pipe. The middle pipe includes two ring parts spaced apart from each other and respectively disposed at each of opposite axial ends of the mount, connection parts each formed to connect the two ring parts to each other, and flap parts each formed at a corresponding one of the two ring parts. Each of the flap parts is bent such that each of the flap parts is inclined outwards in a radial direction of the mount. when a pipe diameter reducing process is performed on the outer pipe to relieve residual stress in the main rubber part, each of the flap parts is deformed inwards in the radial direction of the mount by the outer pipe having a reducible diameter so that an inclination angle of each of the flap parts is changed relative to the corresponding one of the ring parts.

In an embodiment, performing the vulcanization molding of the main rubber part may include: forming the flow path grooves each extending in a circumferential direction on an outer circumferential surface of the main rubber part; and embedding the two ring parts and the flap parts of the middle pipe in bridge portions of the main rubber part, the bridge portions being respectively located on opposite sides of the flow path grooves in a cross section of the mount.

In another embodiment, performing the pipe diameter reducing process may include: changing an inclination angle of each of the flap parts and deforming rubber portions of the main rubber part, the rubber portions surrounding the flap parts; and reducing a length of each of the bridge portions of the main rubber part in the cross section of the mount.

In still another embodiment, each of the flap parts may be formed along a corresponding one of edge portions of the two ring parts, the edge portions facing each other. Each of the flap parts may be formed to have a plate shape protruding toward an opposite one of the two ring parts.

In yet another embodiment, each of the two ring parts may have a hemming part having an edge end. The edge end of the hemming part of each of the two ring parts may respectively correspond to each of opposite end positions of the mount in an axial direction, and the edge end of the hemming part of each of the two ring part may be folded inwards in the radial direction.

In still yet another embodiment, the middle pipe may have grooves each formed on an outer circumferential surface of the middle pipe. Each of the grooves being formed along a corresponding one of boundary lines respectively formed between each of the two ring parts and each of the flap parts. Each of the flap parts may be bent, from a corresponding one of the grooves, outwards in the radial direction of the mount relative to each of the two ring parts before performing the pipe diameter reducing process.

In a further embodiment, performing the vulcanization molding of the main rubber part may include respectively forming rubber grooves on surfaces exposed outwards from respective bridge portions of the main rubber part. Each of the rubber grooves may relieve residual stress concentration during cooling after performing the vulcanization molding of the main rubber part.

In another further embodiment, the rubber grooves may be respectively formed on an upper side of the inner pipe and a lower side thereof, and each of the rubber grooves may be formed to have a shape extending to have a predetermined length in a circumferential direction.

Other aspects and embodiments of the disclosure are discussed below.

It is understood that the terms “vehicle”, “vehicular”, and other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are described in detail with reference to certain embodiments thereof illustrated in the accompanying drawings which are given hereinbelow by way of illustration only, and thus are not limitative of the present disclosure, and wherein:

FIGS. 1 and 2 are views showing a conventional mount;

FIG. 3 is a view illustrating a pipe diameter reducing process;

FIG. 4 is a view illustrating a state in which the pipe diameter reducing process is impossible due to a middle pipe;

FIG. 5 is a cutaway perspective view showing a vehicle mount according to an embodiment of the present disclosure;

FIG. 6 is an exploded perspective view showing a configuration of the vehicle mount according to the embodiment of the present disclosure;

FIG. 7 is perspective views showing a middle pipe of the vehicle mount according to the embodiment of the present disclosure;

FIG. 8 is a view showing a ring part and a flap part of the middle pipe in the vehicle mount according to the embodiment of the present disclosure;

FIG. 9 is a perspective view showing a state in which an orifice member is coupled to a vulcanized and molded main rubber part in the vehicle mount according to the embodiment of the present disclosure;

FIG. 10 is a perspective view showing the orifice members in the vehicle mount according to the embodiment of the present disclosure;

FIG. 11 is cross-sectional views showing a state before the pipe diameter reducing process is performed on the vehicle mount according to the embodiment of the present disclosure, and a state after the pipe diameter reducing process is performed on the vehicle mount according to the embodiment of the present disclosure;

FIG. 12 is a perspective view showing a rubber groove in the vehicle mount according to the embodiment of the present disclosure; and

FIG. 13 is a view showing a manufacturing process of the vehicle mount according to the embodiment of the present disclosure.

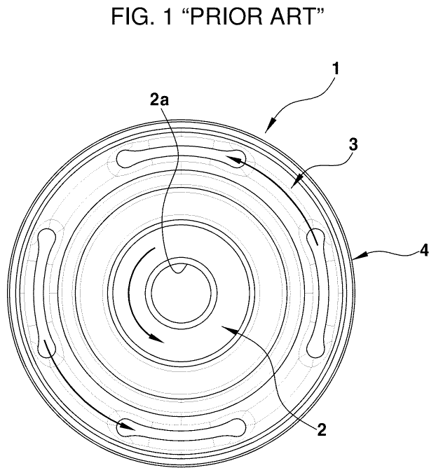

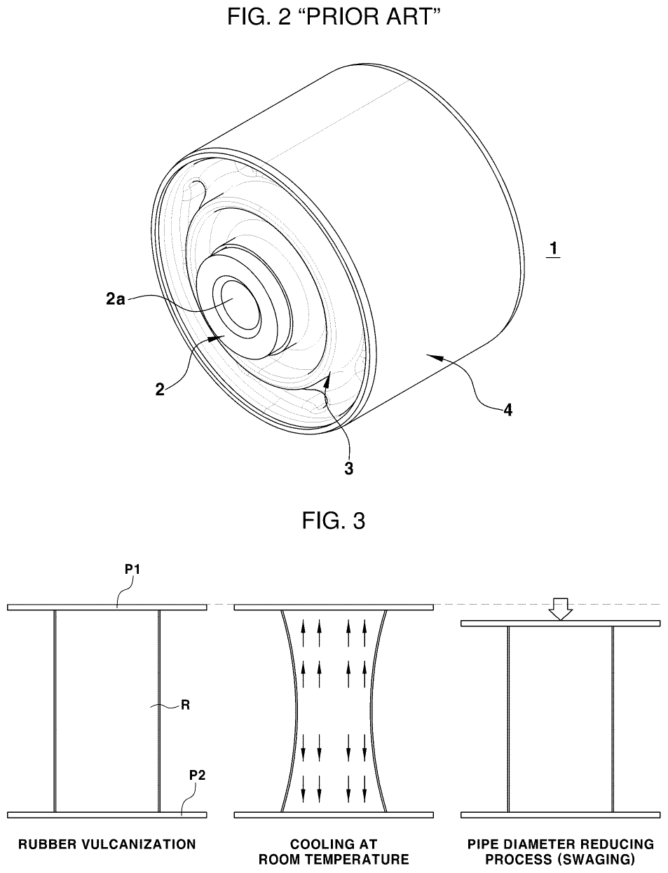

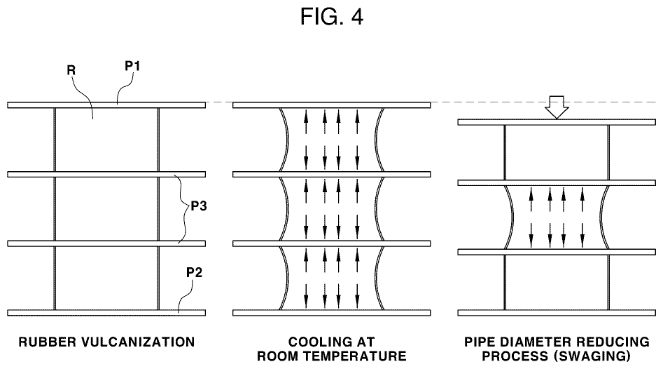

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment. The drawings described herein are for illustration purposes only and are not intended to limit the scope of the present disclosure.

In the figures, reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below. Specific structural or functional descriptions given in connection with the embodiments of the present disclosure are merely illustrative for the purpose of describing embodiments according to the concept of the present disclosure, and the embodiments according to the concept of the present disclosure may be implemented in various forms. Further, it should be understood that the present description is not intended to limit the disclosure to the embodiments. On the contrary, the disclosure is intended to cover not only the embodiments, but also various alternatives, modifications, equivalents, and other embodiments, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, i.e., “between” and “directly between” or “adjacent to” and “directly adjacent to”, should be interpreted in the same manner. When a component, device, element, or the like of the present disclosure is described as having a purpose or performing an operation, function, or the like, the component, device, or element should be considered herein as being “configured to” meet that purpose or to perform that operation or function.

The same reference numerals represent the same components throughout the specification. Additionally, the terms in the specification are used merely to describe embodiments and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

The present disclosure provides a vehicle mount and a manufacturing method thereof capable of relieving residual stress generated during a cooling process of a vulcanized main rubber part and preventing deterioration in durability due to the residual stress.

To this end, in the present disclosure, a flap structure is applied to a middle pipe so as to provide the same effect as that of a conventional pipe diameter reducing process (pipe swaging) by, during the pipe diameter reducing process, changing an angle of a flap part, reducing a length of a bridge portion of a main rubber part, and changing a rubber portion surrounding the flap part. In this manner, it is possible to relieve residual stress in the main rubber part and to prevent deterioration in durability due to the residual stress.

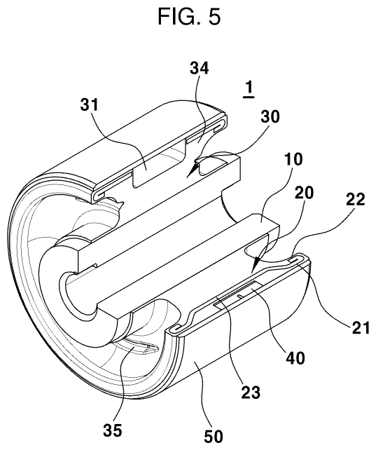

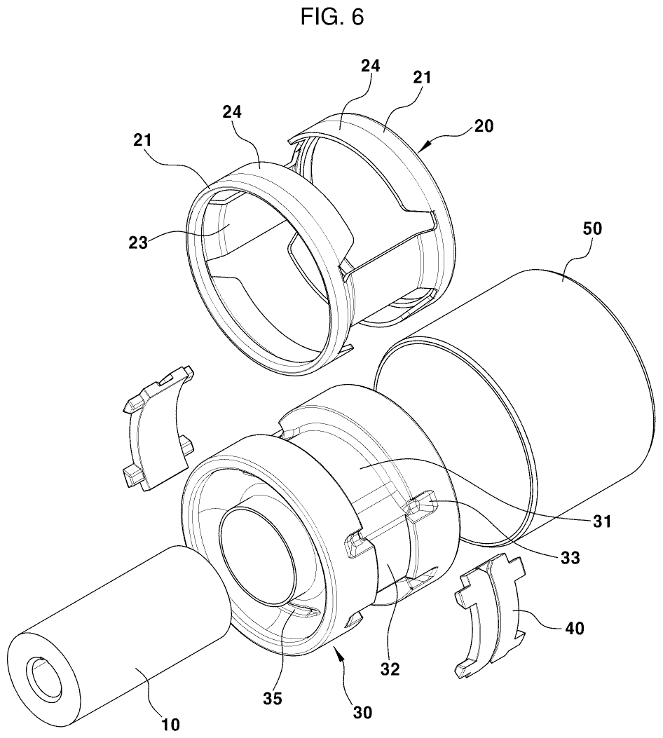

FIG. 5 is a cut-away perspective view showing a vehicle mount according to an embodiment of the present disclosure, and FIG. 6 is an exploded perspective view showing a configuration of the vehicle mount according to the embodiment of the present disclosure.

In FIG. 6, a middle pipe 20 is shown separately from a main rubber part 30. In a mount 1 of the present disclosure, the middle pipe 20 may be a non-exposed component that is embedded in the main rubber part 30. Specifically, at least a part or all of the middle pipe 20 may be embedded in the vulcanized and molded main rubber 30. Accordingly, the middle pipe 20 may not be visible from the outside.

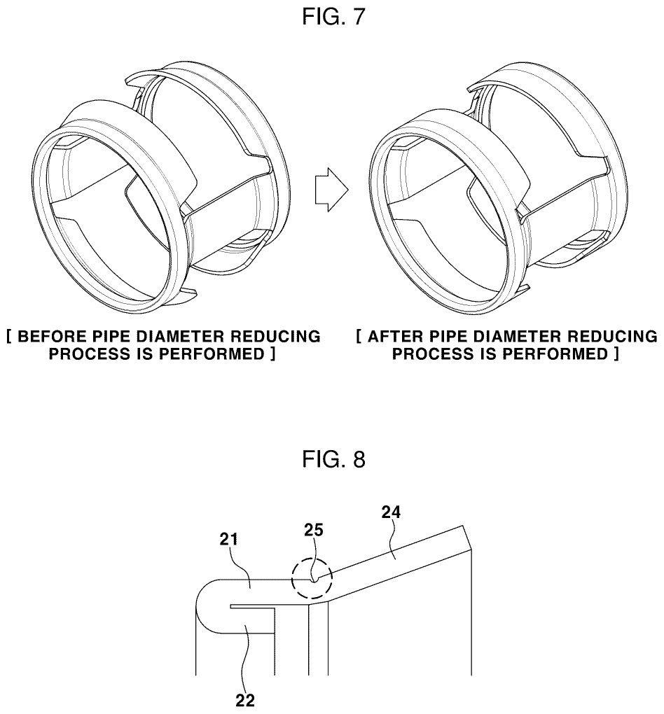

FIG. 7 is a perspective view showing the middle pipe in the vehicle mount according to the embodiment of the present disclosure. The drawing on the left side of FIG. 7 shows a state before the pipe diameter reducing process is performed on the middle pipe 20, and the middle pipe 20 shown in the drawing is put into a manufacturing process for the vehicle mount.

The drawing on the right side of FIG. 7 shows the state of the middle pipe 20 in the vehicle mount as a finished product. The middle pipe 20 shown in this drawing is in the same state as that of the middle pipe 20 shown in FIG. 5. The middle pipe 20 is in a state in which the pipe diameter reducing process is completely performed thereon.

In the vehicle mount as a finished product, an inner pipe, a middle pipe, a main rubber part, an orifice member, and an outer pipe are combined with each other. In the drawing on the right side of FIG. 7, the inner pipe, the main rubber part, the orifice member, and the outer pipe are omitted in the drawing to clearly show a configuration and a shape of the middle pipe 20.

As shown in the drawing, the mount 1 according to the embodiment of the present disclosure includes an inner pipe 10, the middle pipe 20, the main rubber part 30, an orifice member 40, and an outer pipe 50. Among the components, the inner pipe 10, the middle pipe 20, and the outer pipe 50 may be made of a metal material as in a known mount.

The inner pipe 10 is provided in a cylindrical shape and has a predetermined diameter and axial length so that a bolt serving as a coupling element may pass through a hollow of the inner pipe 10. The outer pipe 50 is provided in a cylindrical shape and has a predetermined diameter and axial length as in a conventional mount.

In addition, the middle pipe 20 includes two ring parts 21 having the same diameter, the two ring parts 21 being spaced apart from each other at a predetermined distance in a mount axial direction, connection parts 23 each formed to extend in the mount axial direction so as to connect the two ring parts 21 to each other, and flap parts 24 each formed to protrude from a corresponding one of the two ring parts 21 along a determined arc section (e.g., each of the flap parts is formed to have a plate shape protruding from a corresponding one of the two ring parts 21 and toward one of the two ring parts that is opposite to the corresponding one of the two ring parts 21). The two ring parts 21, the connection parts 23, and the flap parts 23 are formed to be integrated with each other. The ring parts 21 are respectively located at the opposite ends of the mount 1 in the axial direction.

Two connection parts 23 may be formed so as to be disposed at a position of 180° in the circumferential direction in the ring parts 21 of the middle pipe 20, and each of the connection parts 23 may be formed in a plate shape having a predetermined thickness and width.

Each of the flap parts 24 is formed in a plate shape having a predetermined thickness. Each of the flap parts 24 may be disposed along a corresponding one of edge portions facing each other in predetermined arc sections respectively provided at the two ring parts 21. Further, each of the flap parts 24 may be formed to protrude toward a corresponding opposite one of the two ring parts 21.

In this case, one flap part 24 is installed at each position between the two connection parts 23 in each ring part 21, and a total of two flap parts 24 may be formed for each ring part 21. Accordingly, four flap parts 24 may be formed in the mount.

In the middle pipe 20, a space between the ring parts 21, the flap parts 24, and the two connection parts 23 becomes a hole filled with the vulcanized and molded main rubber part 30. In this structure, opposite ends of the respective flap parts 24 and the connection parts 23 are not directly connected to each other.

In other words, recessed portions 26 may be respectively formed in spaces between the flap parts 24 and the connection parts 23 so that the opposite ends of the respective flap parts 24 and the connection parts 23 are not directly connected to each other. For example, each of the recessed portions is formed in each of spaces provided between each of opposite ends of the respective flap parts and an adjacent connection part among the two connection parts. When the recessed portions 26 are formed in this manner, only the ring parts 21 are respectively provided at sections respectively formed between the opposite ends of the flap parts 24 and the connection parts 23. In other words, the flap parts and the connection parts are not formed at the recessed portions such that at sections having the recessed portions respectively formed therein, only corresponding portions of the two ring parts are formed.

FIG. 8 shows the ring part and the flap part of the middle pipe in the mount according to the embodiment of the present disclosure and is a cross-sectional view taken along line “A-A” in FIG. 7. As shown in the drawing, a folded hemming part 22 may be formed along the outer edge portion of the ring part 21 over the entire circumference of the ring part 21.

The hemming part 22 may be formed through a hemming process in which the edge ends of the two ring parts 21 respectively corresponding to opposite end positions in the axial direction of the mount 1 are folded inwards, respectively. The hemming part 22 of the ring part 21 is formed to reinforce strength. By forming the hemming part 22, deformation of the ring parts 21 may be minimized during the pipe diameter reducing process.

In addition, as shown in the drawing, the flap part 24 is formed to be bent outwards in the radial direction at a predetermined angle along a boundary line between the ring part 21 and the flap part 24 so as to be inclined relative to the ring part 21 in cross section. In this case, a groove 25 may be provided on the outer circumferential surface of the middle pipe 20 and may be formed along the entire circumference of the boundary line between the ring part 21 and the flap part 24.

In a case in which the pipe diameter reducing process is not performed yet, in a state in which the middle pipe 20 is embedded in the main rubber part 30, the flap part 24 is provided in a state of being bent outwards from the groove 25 in the radial direction of the mount relative to the ring part 21.

In this manner, when the groove 25 is formed along the boundary line between the ring part 21 and the flap part 24, a defect rate may be reduced during the pipe diameter reducing process (pipe swaging). It is advantageous to form the groove 25 using a pressing mark or a change in thickness instead of using a machined notch.

Further, on the outer circumferential surface of the main rubber part 30, a flow path groove 31 is disposed at a middle position of the mount in the axial direction and is formed to extend in the circumferential direction. The flow path groove 31 is formed in the main rubber part 30 so as to have a predetermined depth, width, and length.

In this case, two flow path grooves 31 may be respectively formed along approximately semicircular sections on the outer circumferential surface of the main rubber part 30, and protruding portions 32 each having a predetermined length in the circumferential direction are formed between the two flow path grooves 31.

In other words, the protruding portions 32 are respectively formed at the ends of the two flow path grooves 31 respectively formed along the semicircular sections in the main rubber part 30, and a total of two protruding portions 32 are formed between the two flow path grooves 31.

The two flow path grooves 31 and the two protruding portions 32 are arranged on the outer circumferential surface of the main rubber part 30 and are formed to be connected to each other in a circular shape at a middle portion of the mount in the axial direction. In other words, each of the short protruding portions 32 is arranged between the long semicircular flow path grooves 31. In this case, the two protruding portions 32 may be formed at an interval of 180° in the circumferential direction on the outer circumferential surface of the main rubber part 30.

The two flow path grooves 31 are portions provided to form a sealed flow path space between the main rubber part 30 and the outer pipe 50 coupled to the outer side of the main rubber part 30. Further, the two flow path grooves 31 enable the vehicle mount as a finished product to be provided with two sealed flow path spaces formed in the circumferential direction.

The two flow path spaces are spaces through which fluid flows in the circumferential direction of the mount 1. The two flow path spaces are spatially separated from each other by each of the protruding portions 32 disposed between the two flow path grooves 31. However, the two flow spaces are connected to each other so as to enable movement of fluid by the orifice members 40 respectively disposed at the protruding portions 32.

In the mount 1 according to the embodiment of the present disclosure, the main rubber part 30 is vulcanized and molded to be integrated with the inner pipe 10 and the middle pipe 20. The inner circumferential surface of the main rubber part 30 is molded so as to be joined to the outer circumferential surface of the inner pipe 10. Additionally, the middle pipe 20 may be inserted into the main rubber part 30 so that all parts including the ring part 21, the flap part 24, and the connection part 23 are embedded in the main rubber part 30.

In this case, the connection parts 23 of the middle pipe 20 may be respectively inserted into the protruding portions 32 of the main rubber part 30 so as not to be exposed to the outside, and each of the orifice member 40 is coupled to and seated on a corresponding one of the outer surfaces of the protruding portions 32 in which the connection parts 23 of the middle pipe 20 are respectively embedded.

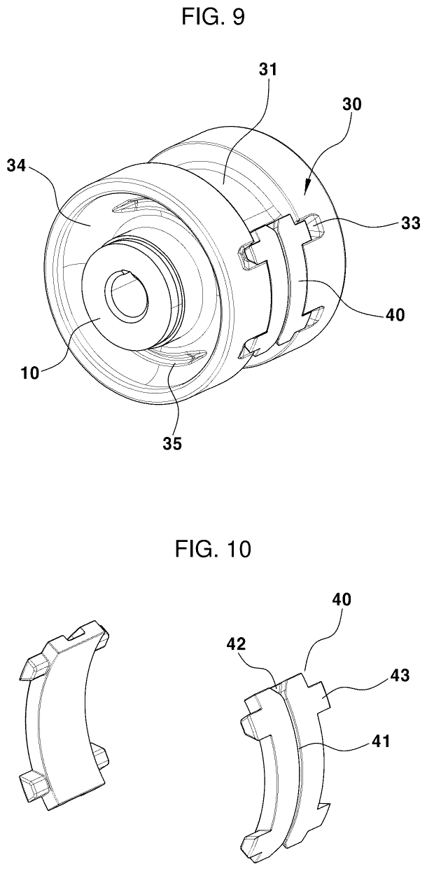

FIG. 9 is a perspective view showing a state in which the orifice members are coupled with the main rubber part 30 in a state in which the main rubber part 30 is vulcanized and molded between the inner pipe and the middle pipe of the mount 1 according to the embodiment of the present disclosure.

Additionally, FIG. 10 is a perspective view showing the orifice member of the mount according to the embodiment of the present disclosure. As shown in FIG. 10, a pair of orifice members 40 are used, and the orifice members 40 may be made of aluminum or plastic.

On the outer surface of each of the orifice members 40, an orifice 41 is formed to enable fluid movement between two sealed flow path spaces formed by the flow path groove 31 of the main rubber part 30 and the outer pipe 50.

In each of the orifice members 40, the orifice 41 is formed in the shape of an elongated channel or a groove having a predetermined width. In order to allow fluid to flow smoothly from the flow path space into the orifice 41, the orifice 41 has expansion flow path parts 42 respectively formed at the opposite ends thereof, and each of the expansion flow path parts 42 has a width formed to be gradually widened toward a corresponding one of the opposite ends of the orifice member 40.

In addition, protrusions 43 are respectively formed on left and right sides at the opposite ends of the orifice member 40, and the main rubber part 30 has insertion grooves 33 each formed at a position corresponding to a corresponding one of the protrusions 43 and configured to allow the corresponding one of the protrusions 43 to be inserted into and coupled thereto.

The insertion grooves 33 formed in the main rubber part 30 are provided to fix the orifice members 40. When each of the protrusions 43 is inserted into a corresponding one of the insertion grooves 33, each of the orifice members 40 may be fixed at a predetermined position in the space between the main rubber part 30 and the outer pipe 50. Additionally, the insertion grooves 33 and the protrusions 43 enable the orifice members 40 to be conveniently positioned in the main rubber part 30.

The outer pipe 50 is assembled with the main rubber part 30 in a state in which the orifice members 40 are assembled with the main rubber part 30. Thereafter, when the pipe diameter reducing process (pipe swaging) is performed, the main rubber part 30 is compressed, and fixation of the orifice member 40 and sealing of the flow path space may be simultaneously achieved.

In other words, in a state in which the main rubber part 30 is compressed and deformed after the pipe diameter reducing process, the insertion grooves 33 of the main rubber part 30 and the protrusions 43 of the orifice member 40 may be reliably fixed and coupled to each other. Furthermore, sealing may be achieved between two flow path spaces and the pair of orifice members 40 so as to enable fluid movement only through the orifices 41 in the two flow spaces between the main rubber part 30 and the outer pipe 50.

FIG. 11 is a cross-sectional view showing a state before the pipe diameter reducing process is performed on the vehicle mount according to the embodiment of the present disclosure, and a state after the pipe diameter reducing process is performed on the vehicle mount according to the embodiment of the present disclosure. The drawing on the left side of FIG. 11 shows the state before the pipe diameter reducing process is performed thereon, and the drawing on the right side of FIG. 11 shows the state after the pipe diameter reducing process is performed thereon.

In the present disclosure, even if the pipe diameter reducing process is performed in a state in which the middle pipe 20 is present in the main rubber part 30, the flap parts 24 of the middle pipe 20 make it possible to obtain the same diameter reducing effect as that obtained by a conventional pipe diameter reducing process. In other words, it is possible to obtain an effect of relieving residual stress.

Specifically, in a state in which the ring parts 21 and the flap parts 24 of the middle pipe 20 are embedded in bridge portions 34 of the main rubber part 30, i.e., rubber portions 36 respectively located on opposite sides of the flow path groove 31 on the cross section in FIG. 11, as shown in the drawing on the left side of FIG. 11, the flap parts 24 of the middle pipe 20 and the rubber portions 36 surrounding the flap parts 24 protrude outwards in the radial direction of the mount 1 before the pipe diameter reducing process is performed.

After assembly of the outer pipe 50, when the pipe diameter reducing process is performed, force is applied inwards in the radial direction of the outer circumferential surface of the outer pipe 50. As the diameter of the outer pipe 50 is reduced (reduced from ϕ1 to ϕ2), the flap parts 24 of the middle pipe 20 and the rubber portions 36 in which the flap parts 24 are embedded are deformed by the force. The angle of the bridge portion 34 in the main rubber part 30 is changed.

Particularly, as shown in the drawing on the right side of FIG. 11, in a state in which there is no deformation of the ring parts 21 respectively reinforced by the hemming parts 22, only the flap parts 24 are deformed, in the inner radial direction of the mount, from the grooves 25 respectively formed along the boundary lines between the ring parts 21 and the flap parts 24, and the angle of each of the flap parts 24 and the angle of each of the rubber portions 36 surrounding the same are changed.

Since the hemming parts 22 each having a folded structure have high strength, it is possible to prevent deformation of the ring parts 21 during the pipe diameter reducing process. Even if force required during the pipe diameter reducing process is applied to each of the ring parts 21, each of the ring parts 21 is not deformed, and only each of the flap parts 24 may be changed in angle relative to each of the grooves 25.

Furthermore, referring to FIG. 11, It is shown that after the pipe diameter reducing process is completed, the flap parts 24 are respectively embedded in the bridge portions 34 of the main rubber part 30 in a state in which the flap parts are not bent in the ring parts 21. The rubber portions 36 respectively surrounding the ring parts 21 and the flap parts 24 are in close contact with and bonded to the inner circumferential surface of the outer pipe 50.

As a result, after the pipe diameter reducing process is completed, the angle of each of the flap parts 24 of the middle pipe 20 and the angle of each of the rubber portions 36 of the main rubber part 30 surrounding the flap parts 24 are changed. Accordingly, as compared with the length of the bridge portion 34 before the pipe diameter reducing process is performed, the length of the bridge portion 34 connecting the inner pipe 10 to the outer pipe 50 in the main rubber part 30 is reduced (reduced from d1 to d2). As a result, residual stress in the main rubber part 30 generated during a cooling process after vulcanization molding may be effectively removed.

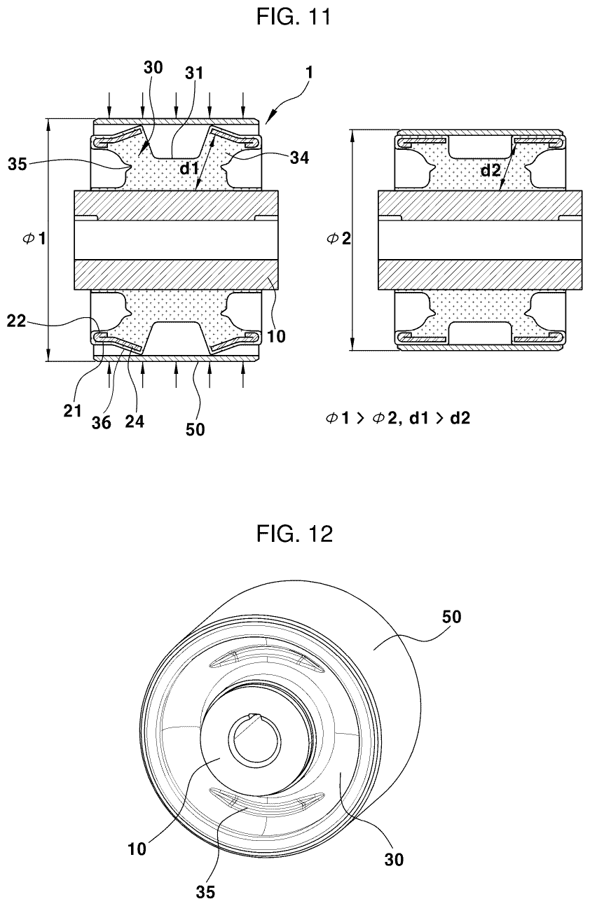

FIG. 12 is a perspective view showing the rubber groove in the mount according to the embodiment of the present disclosure. Portions in the main rubber part 30 of the mount 1, the portions connecting the inner pipe 10 to the outer pipe 50 and being respectively located on opposite sides of the flow path grooves 31 in cross section, are each referred to as the bridge portion 34. (refer to FIG. 11). As shown in FIG. 12, a rubber groove 35 is formed in an intermediate position of the surface of the bridge portion 34 exposed outwards from the main rubber part 30.

The rubber groove 35 may be formed in each of the bridge portions 34 respectively located on the opposite sides of the flow path grooves 31. Further, the rubber grooves 35 may be respectively formed on the upper and lower sides of the inner pipe 10. Additionally, each of the rubber grooves 35 may be formed in a long and incised shape so as to have a predetermined length in the circumferential direction of the mount 1 at each position of the upper and lower sides of the inner pipe 10.

In this manner, the rubber grooves 35 are respectively provided on the exposed outer surfaces of the bridge portions 34 respectively located on the opposite sides of the flow path grooves 31 and are respectively formed on the upper and lower sides of the inner pipe 10. As a result, when the main rubber part 30 is cooled after vulcanization molding, residual stress concentration may be relieved by the rubber grooves 35.

In other words, as described above, residual stress is relieved by, during the pipe diameter reducing process, changing the angle of the flap part 24, deforming the rubber portion surrounding the same, and reducing the length of the bridge portion 34, and additionally, residual stress concentration may be relieved by the rubber groove 35 having the incised shape during cooling after the main rubber part 30 is vulcanized and molded.

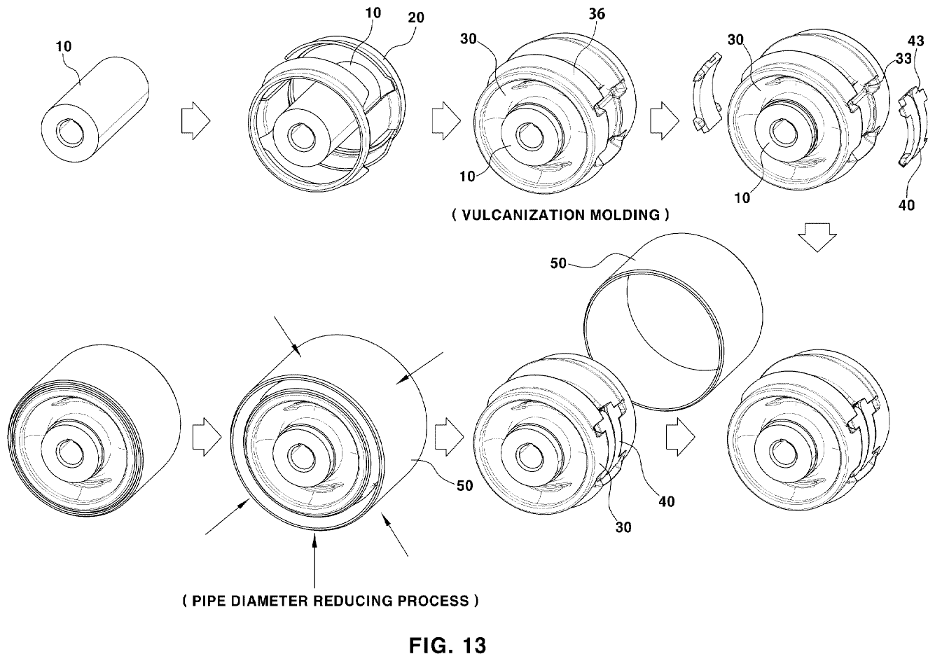

FIG. 13 is a view showing a manufacturing process of the mount according to the embodiment of the present disclosure. After the inner pipe 10 and the middle pipe 20 are placed in a mold, the main rubber part 30 is vulcanized and molded in the mold. After the main rubber part 30 is demolded from the mold, each of the orifice members 40 is assembled with the surface of a corresponding one of the protruding portions 32 of the main rubber part 30.

The pair of orifice members 40 is assembled by inserting each of the protrusions 43 of the orifice members 40 into a corresponding one of the insertion grooves 33 formed in the main rubber part 30, and then the outer pipe 50 is assembled with the outer side of the main rubber part 30 having the orifice member 40 coupled thereto.

Thereafter, a pipe diameter reducing process is performed by applying force acting radially inwards to the outer circumferential surface of the outer pipe 50. Through the pipe diameter reducing process, fluid-filled flow path spaces, i.e., two flow path spaces each formed by the flow path groove 31 of the main rubber part 30 and the outer pipe 50, are sealed.

In the mount 1 that is finally completed by performing the pipe diameter reducing process in this manner, residual stress in the main rubber part 30 generated during cooling may be effectively relieved by changing the angle of the flap part 24, deforming a rubber portion surrounding the flap part 24, and reducing the length of the bridge portion 34, thereby making it possible to improve durability of the mount 1.

As is apparent from the above description, the present disclosure provides a vehicle mount capable of effectively relieving residual stress in a main rubber part generated during cooling by, during a pipe diameter reducing process, changing an angle of a flap part, deforming a rubber portion surrounding the flap part, and reducing a length of the bridge portion of the main rubber part, thereby making it possible to improve durability of the vehicle mount.

The disclosure has been described in detail with reference to embodiments thereof. However, it should be appreciated by those having ordinary skill in the art that changes may be made in these embodiments without departing from the principles and spirit of the disclosure, the scope of which is defined in the appended claims and equivalents thereto.

What is claimed is:

1. A vehicle mount comprising:
an inner pipe;
an outer pipe disposed outside the inner pipe;
a main rubber part interposed between the inner pipe and the outer pipe; and
a middle pipe embedded in the main rubber part and coupled to the main rubber part,
wherein the middle pipe comprises:
two ring parts spaced apart from each other and respectively disposed at each of opposite axial ends of the mount,
connection parts each formed to connect the two ring parts to each other, and
flap parts each formed at a corresponding one of the two ring parts,
wherein each of the flap parts is bent such that each of the flap parts is inclined outwards in a radial direction of the mount, and
wherein when a pipe diameter reducing process is performed on the outer pipe to relieve residual stress in the main rubber part, each of the flap parts is configured to be deformed inwards in the radial direction of the mount by the outer pipe having a reducible diameter so that an inclination angle of each of the flap parts is changed relative to the corresponding one of the ring parts.

2. The vehicle mount of claim 1, wherein each of the flap parts is formed along a corresponding one of edge portions of the two ring parts, the edge portions facing each other, and wherein each of the flap parts is formed to have a plate shape protruding toward an opposite one of the two ring parts.

3. The vehicle mount of claim 2, wherein:
the middle pipe has two connection parts formed to extend in an axial direction of the mount and connect the two ring parts to each other, and
each of the flap parts is formed at the corresponding one of the two ring parts and formed between the two connection parts.

4. The vehicle mount of claim 3, wherein:
each of the flap parts is formed to have a predetermined length in a circumferential direction of the corresponding one of the two ring parts and formed between the two connection parts, and
recessed portions are respectively formed in each of spaces between each of opposite ends of the flap parts and the two connection parts, and at sections having the recessed portions respectively formed therein, only corresponding portions of the two ring parts are formed.

5. The vehicle mount of claim 1, wherein each of the two ring parts has a hemming part, the hemming part having an edge end, wherein the edge end of the hemming part of each of the two ring parts respectively corresponds to each of opposite end positions of the mount in an axial direction, and wherein the edge end of the hemming part of each of the two ring parts is folded inwards in the radial direction.

6. The vehicle mount of claim 1, wherein:
the middle pipe has grooves each formed on an outer circumferential surface of the middle pipe, each of the grooves being formed along a corresponding one of boundary lines respectively formed between each of the two ring parts and each of the flap parts, and
each of the flap parts is bent, from a corresponding one of the grooves, outwards in the radial direction of the mount relative to each of the two ring parts before performing the pipe diameter reducing process.

7. The vehicle mount of claim 1, wherein:
a flow path groove is formed on an outer circumferential surface of the main rubber part, the flow path groove extending in a circumferential direction, and
the main rubber part has bridge portions respectively located at opposite sides of the flow path groove in a cross section of the mount, and wherein the ring parts and the flap parts of the middle pipe are embedded in the bridge portions.

8. The vehicle mount of claim 7, wherein:
each of the flap parts maintains, after the pipe diameter reducing process is performed, a state of being embedded in the main rubber part without bending relative to the corresponding one of the ring parts, and
after the pipe diameter reducing process is performed, rubber portions of the main rubber part contact an inner circumferential surface of the outer pipe, the rubber portions surrounding the ring parts and the flap parts.

9. The vehicle mount of claim 7, wherein the main rubber part has rubber grooves respectively formed on surfaces exposed outwards from the respective bridge portions of the main rubber part, wherein each of the rubber grooves configured to relieve residual stress concentration during cooling after vulcanization molding of the main rubber part.

10. The vehicle mount of claim 9, wherein the rubber grooves are respectively formed on an upper side of the inner pipe and a lower side thereof, and each of the rubber grooves is formed to have a shape extending to have a predetermined length in the circumferential direction.

11. A manufacturing method of a vehicle mount, the manufacturing method comprising:
performing vulcanization molding of a main rubber part after placing an inner pipe and a middle pipe in a mold;
coupling orifice members to the main rubber part such that the orifice members are positioned between flow path grooves formed in the main rubber part cooled after the vulcanization molding;
assembling an outer pipe with an outer side of the main rubber part in a state in which the orifice members are coupled to the main rubber part; and
performing a pipe diameter reducing process to relieve residual stress in the main rubber part and reduce a diameter of the outer pipe,
wherein the middle pipe comprises two ring parts spaced apart from each other and respectively disposed at each of opposite axial ends of the mount, connection parts each formed to connect the two ring parts to each other, and flap parts each formed at a corresponding one of the two ring parts,
wherein each of the flap parts is bent such that each of the flap parts is inclined outwards in a radial direction of the mount, and
wherein when a pipe diameter reducing process is performed on the outer pipe to relieve residual stress in the main rubber part, each of the flap parts is deformed inwards in the radial direction of the mount by the outer pipe having a reducible diameter so that an inclination angle of each of the flap parts is changed relative to the corresponding one of the ring parts.

12. The manufacturing method of claim 11, wherein performing the vulcanization molding of the main rubber part comprises:
forming the flow path grooves each extending in a circumferential direction on an outer circumferential surface of the main rubber part; and
embedding the two ring parts and the flap parts of the middle pipe in bridge portions of the main rubber part, the bridge portions being respectively located on opposite sides of the flow path grooves in a cross section of the mount.

13. The manufacturing method of claim 12, wherein performing the pipe diameter reducing process comprises:
changing an inclination angle of each of the flap parts and deforming rubber portions of the main rubber part, the rubber portions surrounding the flap parts; and
reducing a length of each of the bridge portions of the main rubber part in the cross section of the mount.

14. The manufacturing method of claim 11, wherein each of the flap parts is formed along a corresponding one of edge portions of the two ring parts, the edge portions facing each other, and wherein each of the flap parts is formed to have a plate shape protruding toward an opposite one of the two ring parts.

15. The manufacturing method of claim 11, wherein each of the two ring parts has a hemming part having an edge end, wherein the edge end of the hemming part of each of the two ring parts respectively corresponds to each of opposite end positions of the mount in an axial direction, and wherein the edge end of the hemming part of each of the two ring parts is folded inwards in the radial direction.

16. The manufacturing method of claim 11, wherein:
the middle pipe has grooves each formed on an outer circumferential surface of the middle pipe, each of the grooves being formed along a corresponding one of boundary lines respectively formed between each of the two ring parts and each of the flap parts, and
each of the flap parts is bent, from a corresponding one of the grooves, outwards in the radial direction of the mount relative to each of the two ring parts before performing the pipe diameter reducing process.

17. The manufacturing method of claim 11, wherein performing the vulcanization molding of the main rubber part comprises respectively forming rubber grooves on surfaces exposed outwards from respective bridge portions of the main rubber part, wherein each of the rubber grooves relieves residual stress concentration during cooling after performing the vulcanization molding of the main rubber part.

18. The manufacturing method of claim 17, wherein the rubber grooves are respectively formed on an upper side of the inner pipe and a lower side thereof, and each of the rubber grooves is formed to have a shape extending to have a predetermined length in a circumferential direction.
